(19) United States
(12) Patent Application Publication
(10) Pub. No.: US 2025/0382033 A1
(43) Pub. Date: Dec. 18, 2025

(54) Modular Electric Hydrofoil Watercraft for Rapid Assembly and Disassembly

(71) Applicant: CPD LTD., Sofia (BG)

(72) Inventor: Dimitar Andreev Andreev, Sofia (BG)

(21) Appl. No.: 19/233,939

(22) Filed: Jun. 10, 2025

(30) Foreign Application Priority Data
Jun. 13, 2024 (BG) 113916
Aug. 23, 2024 (EP) 24196191.1

(51) Int. Cl. B63B 32/10; B63B 1/24; B63B 32/66; B63H 21/17; H01R 13/52

(52) U.S. Cl. CPC B63B 32/10; B63B 1/242; B63B 1/246; B63B 32/66; B63H 21/17; H01R 13/5219

(57) ABSTRACT

The electric hydrofoil watercraft according to the invention provides detachable and hermetic electrical connection via contact pins for cables providing power to underwater propulsion means between above-water platform and one side of the mast and between the fuselage of the hydrofoil and the other side of the mast.

### CROSS-REFERENCE TO RELATED APPLICATION

The present application claims priority to Bulgarian Application No. BG113916, filed Jun. 13, 2024, and European Patent Application No. EP24196191.1, filed Aug. 23, 2024. The priority applications, BG113916 and EP24196191.1, are hereby incorporated by reference.

### TECHNICAL FIELD

The invention relates to an electric hydrofoil watercraft, which is used in the field of water sports.

### PRIOR ART

Watercraft with hydrofoils, such as surf foils, wing foils, kite foils, e-foils and others, consist of an above-water part-a board, an underwater part-a hydrofoil, usually comprising fuselage, front wing and at least one stabilizer, as well as vertical mast connecting the board and the hydrofoil. These watercrafts are used to practice water sports and often need to be transported from one place to another. Transport is also necessary for their delivery to the commercial network. Due to their specific design-elongated elements located in at least three intersecting planes, hydrofoil watercrafts take up a lot of space and need large cargo vehicles to transport them. Also, the storage of these products requires premises with large spaces. For these reasons, there is a need for hydrofoil watercraft to be demountable, the mast being able to be demounted from the board, from the fuselage, or both.

The mast has to be detachable also in cases where one mast needs to be easily replaced with another, for example, a shorter or longer mast, without having to change the entire hydrofoil.

A means for detachable connection of mast to board is known from European patent application EP4276006A1, comprising a fixing plate mounted on the board and a coupling element mounted on the mast. The coupling element is shaped so that when mounted it is inclined to said fixing plate and it is rotated relative to it to the assembled position, it also comprises a rear end with a threaded opening which, when said coupling element is in assembled position to said fixing plate, is located coaxially with a threaded opening in the fixing plate. To fix the coupling element to the fixing plate, the connecting system also comprises a screw that connects the two parts together. This embodiment is complex and requires the use of tools to assemble and disassemble the mast and the board.

Patent application US2020361580A1 discloses a watercraft-a surf foil, with demountable mast detachably attached to a board by means of a base fixedly secured to the underside of the board and a coupling element attached to the mast and detachably attached to the base. The coupling element is movable between a first position in which the coupling element is rotated about and disengaged from the base, and a second position in which the coupling element abuts and is secured to the base by a cam-lever locking means. This type of detachable connection does not require the use of tools to assemble or disassemble the mast. The solution is not applicable to electric hydrofoils where there are connecting cables, electronics and motor that require special connection and waterproofing.

European patent application EP18882953.5 discloses a watercraft with a hydrofoil in which a module housing the electronics of the device is attached to the top of the mast, which module can be removably attached to the board of the watercraft. For this purpose, a corresponding cavity is provided in the board, in which the module is placed and is removably attached, by means of fixing means such as bolts, to the board. In this way, the board can be separated from the hydrofoil and the mast. The module also has electrical contacts for connecting to a source of electrical current. This embodiment is complex and requires assembly of the mast with the module to the board with additional fasteners using tools.

None of the known and described above hydrofoil watercraft offers a solution for quick and easy disassembly and assembly of a hydrofoil unit of an electric watercraft to its constituting parts. None of the described solutions is suitable for this type of solution because any of the described designs would destroy the tightness and integrity of the electrical connection between the individual components of the watercraft.

Solutions are known from the prior art that describe electric watercrafts with a mast connecting an above-water platform to a fuselage and hydrofoils. Electric motor is connected to the lower end of the mast. The mast is integrated with a module placed at its top, having a waterproof housing, which houses control, regulation and communication electronics, and with this module, the mast is bolted to the above-water platform. The module is connected to a power source located in the above-water platform. The lower end of the mast is attached to the fuselage of the hydrofoil by means of a bolted attachment element, which forms part of the outer profile of the fuselage. The design thus described reveals a modular construction of hydrofoil, but disassembly and assembly of the mast to the above-water platform is not easy and fast, the mast is disassembled from the above-water platform together with the module at its top where the electronics are arranged, which means that replacement of the mast requires replacing the electronics module as well, as each mast must have a separate electronics module.

### SUMMARY OF THE INVENTION

The object of the invention is to create modular and demountable hydrofoil electric watercraft, so as to reduce the space occupied by the underwater part (mast and fuselage) during transport and storage, and to allow easy and cheap replacement of the mast with another, for example, longer or shorter mast, so that the disassembly and assembly of the watercraft is done with a minimum use of tools and fixtures, that is, it is easy and fast, while maintaining the tightness of the electrical connection between power supply-electric motor-board, and preventing its destruction.

This object is achieved by creating a modular electric hydrofoil watercraft comprising:
above-water platform,
hydrofoil comprising a fuselage with a front wing and at least one stabilizer,
mast connecting directly or indirectly the above-water platform to the hydrofoil fuselage, there is one coupling element at each end of the mast for mechanical fastening, respectively, to the above-water platform and to the fuselage of the hydrofoil, and
underwater propulsion means mounted to the fuselage, said underwater propulsion means is for creating horizontal thrust and has at least one electric motor connected by wire via electric cables located inside the mast to a source of electricity located in or on the above-water platform.

The mast is adapted to be quickly and easily disassembled from and assembled to the above-water platform and the fuselage, because the mast is detachably connected to the above-water platform and to the hydrofoil fuselage, and, at least one attachment module is provided for detachable mechanical attachment of a corresponding coupling element of the mast at the location where the mast is mounted to the above-water platform and the fuselage.

A detachable and hermetic electrical connection is provided for cables providing power and/or communication to the underwater propulsion means between the above-water platform and one side of the mast and between the hydrofoil fuselage and the other side of the mast.

Waterproof and electrically nonconductive seals are placed between the above-water platform and the mast and between the fuselage and the mast when the detachable connection is built.

The detachable and hermetic electrical connection between the electrical cables in the mast and, accordingly, in the above-water platform and the fuselage of the hydrofoil is contact pins of the electrical cables provided at the places where the mast is mounted to the above-water platform and the fuselage, and on both sides of the mast, which contact pins are preferably coated with highly conductive material. The contact pins of the above-water platform and the fuselage are in electrical contact with the contact pins of the mast in the assembled state of the watercraft. It is possible that all the contact pins are power lugs, and it is also possible that some of the contact pins provide a communication between electronic modules located on/in the board and the fuselage. The contact pins of adjacent cables are electrically isolated from each other.

Control, regulation and communication electronics of the hydrofoil, which, according to the invention, is a set of one or more controllers, more specifically an electronic speed controller controlling the electric motor, and an electronic module controlling the entire system, called on-board controller or on-board computer, is mounted in the above-water platform and/or the fuselage.

The absence of control electronics mounted to the mast allows for easier assembly and disassembly and easier implementation of secure isolation and, accordingly, a more reliable electrical connection.

In a preferred embodiment of the invention, the contact pins are replaceable and the cables of the wire connection between the mast, the above-water platform and the fuselage are directly or indirectly mounted to them.

In a preferred embodiment of the invention, at least on one side of the connection mast-above-water platform and/or of the connection mast-fuselage, metal cable lugs are mounted on the ends of the cables, which metal cable lugs are detachably connected to the contact pins. In the contact area between the contact pins and the cable lugs, each of the contact pins and cable lugs has a hemispherical recess, the two recesses enclose a common spherical cavity in which a spherical element of electrically highly conductive material with a diameter corresponding to the spherical cavity is located, which spherical element is in electrical contact with both lugs.

Preferably, the spherical element is made of a softer metal than the metal from which the contact pins and cable lugs are made.

In a preferred embodiment of the invention, the contact pins of the mast, and/or the above-water platform, and/or the fuselage are spring-loaded by means of spring elements for contact pins mounted around the corresponding contact pins, such that in the mounted position of the mast and when the electrical connection is established, spring elements of the spring-loaded contact pins of at least one of the parts of the watercraft are tensioned.

In a preferred embodiment of the invention, the connection between the above-water platform and the mast and/or between the mast and the fuselage of the hydrofoil is manually detachable.

In a preferred embodiment of the invention, an attachment module of the above-water platform and/or attachment module of the fuselage is made with a wedge-shaped socket, tapering in direction of the above-water platform or the fuselage, respectively, and the corresponding coupling element of the mast, which provides the assembly, respectively, with the above-water platform or with the fuselage has a wedge-shaped end, tapering in direction of the wedge-shaped socket to which it is mounted.

In a preferred embodiment of the invention, the mast and at least one of its coupling elements are detachably connected to each other, and a waterproof and electrically nonconductive seal is arranged between them.

In a preferred embodiment of the invention, the connection between the above-water platform and the mast and/or between the mast and the fuselage of the hydrofoil is provided by an attachment module mounted, respectively, to the above-water platform and/or the fuselage, which is a system of two carriers, respectively first carrier and second carrier that are spaced less than the length of the coupling element of the mast. The attachment module has unlocked and locked position, wherein the first carrier has, on the opposite to the second carrier side, engaging element for a corresponding first engaging element of the mast's coupling element. The mast's coupling element is adapted to perform a rotational movement centered on the first engaging element of the first carrier between unlocked and locked position, such that in the locked position of the attachment module, an engaging element of the second carrier forms a releasable assembly with a second engagement element of the mast's coupling element, arranged on the opposite to the first engaging element side of the coupling element.

In one embodiment of the invention, the engaging element of the first carrier is a groove, and the engaging elements of the coupling element of the mast are ribs, the second carrier is a rotating body, having engaging element in the form of a groove. The grooves of the two carriers are opposite to each other in locked position of the attachment module, wherein the rotating body is designed with the ability to perform synchronous to the rotational movement of the coupling element of the mast reciprocating-rotating movement around an axis that is transverse to the extension of the above-water platform and/or the fuselage, when engaging with the coupling element of the mast, the rotating body has a locking means to hold the mast in the assembled state.

In another embodiment of the invention, the connection between the above-water platform and the mast and/or between the mast and the fuselage of the hydrofoil is a rail connection, wherein in assembled state the mast is fixed by a detachable attachment module, respectively, to the above-water platform and/or to the fuselage.

In another embodiment of the invention, the above-water platform and/or the fuselage of the hydrofoil have a connection socket for mast designed so that the coupling element of the mast, in the assembled state, is inserted into the socket in direction parallel to the extension of the mast, wherein in the assembled state the mast is fixed by means of an attachment module to the above-water platform and/or to the fuselage.

In a preferred embodiment of the invention, the above-water platform has a box for electronic components located in a cavity in the board, to which box the attachment module for the mast is attached detachably or integrally and in which box the contact pins of the cables of the above-water platform are located.

In a preferred embodiment of the invention, the coupling elements on both sides of the mast are identical, and the attachment modules of the above-water platform and the fuselage are identical also.

Advantages of the electric watercraft according to the invention are:
the use of a separate mast comprising only the electrical cables and their contact elements, without other electronic components, which is detachable in relation to the board and the fuselage, and enables the conduction of electricity between them;
the mast can be changed without tools at hand, and thus it can be replaced by masts of different heights, depending on the need, in order to use it for suitable type of surfing-sport, tourist, educational or other;
replacing the mast does not require replacing the entire fuselage;
the replacement of the mast ensures electricity flow between the board and the fuselage without any problems;
a complete hermetic connection between the board, the mast and the fuselage is ensured in every assembly of the electric watercraft;
in disassembled state, the electric watercraft can be stored compactly and transported more easily, which lowers the corresponding economic costs for storage and transport;
easier repair is ensured if needed, due to the disassembly to smaller parts of the electric watercraft.

### BRIEF DESCRIPTION OF THE DRAWINGS

Further in the description, the watercraft of the invention is explained by a preferred embodiments, given as non-limiting the scope of the invention examples, with reference to the attached figures, where:

FIG. 1 is axonometric view of the hydrofoil electric watercraft according to a preferred embodiment of the invention, where the coupling element of the mast carries out assembly by rotational movement relative to the attachment modules of the above-water platform and the fuselage.

FIG. 2 is axonometric view of watercraft according to another embodiment of the invention, where the assembly between the mast and, respectively, the above-water platform and the fuselage is carried out by means of a rail connection.

FIG. 3 is axonometric view of watercraft according to another embodiment of the invention, where the assembly between the mast and, respectively, the above-water platform and the fuselage is carried out by reciprocating movement in direction parallel to the extension of the mast.

FIG. 4 is schematic view in partial vertical section of a completed assembly between the mast and the fuselage, according to the preferred embodiment of the invention shown in FIG. 1.

FIG. 5 is schematic view in partial vertical section of the mast-fuselage assembly of FIG. 4 during the process of assembly.

FIG. 6 is simplified side view in vertical section of the assembly between the mast and above-water platform during the process of assembly.

FIG. 7 is simplified side view in vertical section of a completed but still unlocked assembly between the mast and above-water platform of FIG. 6.

FIG. 8 is vertical cross-sectional view of a completed assembly between the coupling element of the mast and attachment module, according to the preferred embodiment of the invention shown in FIGS. 1 and 3, where the coupling element and its corresponding socket of the attachment module are wedge-shaped.

FIG. 9 is vertical cross-sectional view of the assembly of FIG. 8 during the process of disassembly.

FIG. 10 is longitudinal section of a connection of cable lug with contact pin, according to a preferred embodiment of the invention.

FIG. 11 is enlarged cross-sectional comparison of the contact area between two contact surfaces, respectively contact between flat surfaces (bottom view) and contact between hemispherical surfaces in unfolded form (top view).

FIG. 12 is partial enlarged cross-sectional view of the contact area between cable lug and contact pin, with a spherical element between them, which is deformed by the pressure in the contact area.

FIG. 13 is partially exploded schematic view of a fuselage's attachment module for mast with contact pins, according to a preferred embodiment of the invention. A similar embodiment can be used for the connection of the mast with the above-water platform.

FIG. 14 is schematic view of the mast end in partially disassembled form, with a coupling element in which the contact pins of the fuselage are fixed, according to a preferred embodiment of the invention.

FIG. 15 is schematic cross-sectional view of connected fuselage and mast, where the contact pins of the fuselage are spring-loaded, according to a preferred embodiment of the invention. An analogous embodiment can be used for the connection of the mast with the above-water platform.

FIG. 16 is simplified side view in vertical section of a completed and locked assembly between the mast and attachment module, according to the preferred embodiment of the invention shown in FIGS. 1, 6 and 7.

FIG. 17 is schematic cross-sectional view of mast connected to above-water platform's attachment module integrated with a box for electronic components.

FIG. 18 is schematic cross-sectional view of fuselage and mast connected by an attachment module.

### EXEMPLARY EMBODIMENTS AND OPERATION OF THE INVENTION

The terms “over”, “under”, “top”, “bottom”, “front”, “rear” in this description and in the claims refer to the relative arrangement of the structural elements as shown in the figures and in the preferred operating position of the device.

The modular electric hydrofoil watercraft, according to a preferred embodiment of the invention shown in the figures, comprises:
above-water platform 1,
hydrofoil comprising a fuselage 5 with a front wing 7 and at least one stabilizer 8,
mast 2 directly or indirectly connecting the above-water platform 1 to the fuselage 5 of the hydrofoil, and at both ends of the mast 2 there is one coupling element 12 for mechanical fastening, respectively, to the above-water platform 1 and to the fuselage 5 of the hydrofoil, and
underwater propulsion means 6 for creating horizontal thrust, which has at least one electric motor connected by wire via electrical cables located inside the mast 2 to a source of electricity located in or on the above-water platform 1.

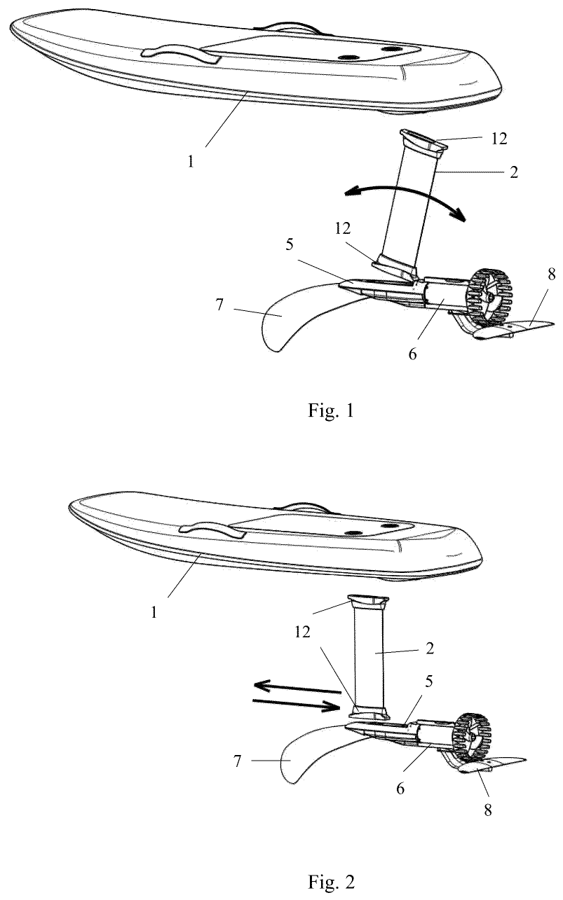

The underwater propulsion means 6 with the at least one electric motor are installed directly or indirectly by the fuselage 5 to a bottom end of the mast 2 in working state of the modular electric hydrofoil watercraft, as shown on FIG. 1.

The mast 2 is adapted to be quickly and easily disassembled from and assembled to the above-water platform 1 and the fuselage 5, because the mast 2 is detachably connected to the above-water platform 1 and the fuselage 5 of the hydrofoil. At least one attachment module 9 for detachable mechanical attachment of a corresponding coupling element 12 of the mast 2 is provided at the location where the mast 2 is mounted to the above-water platform 1 and the fuselage 5.

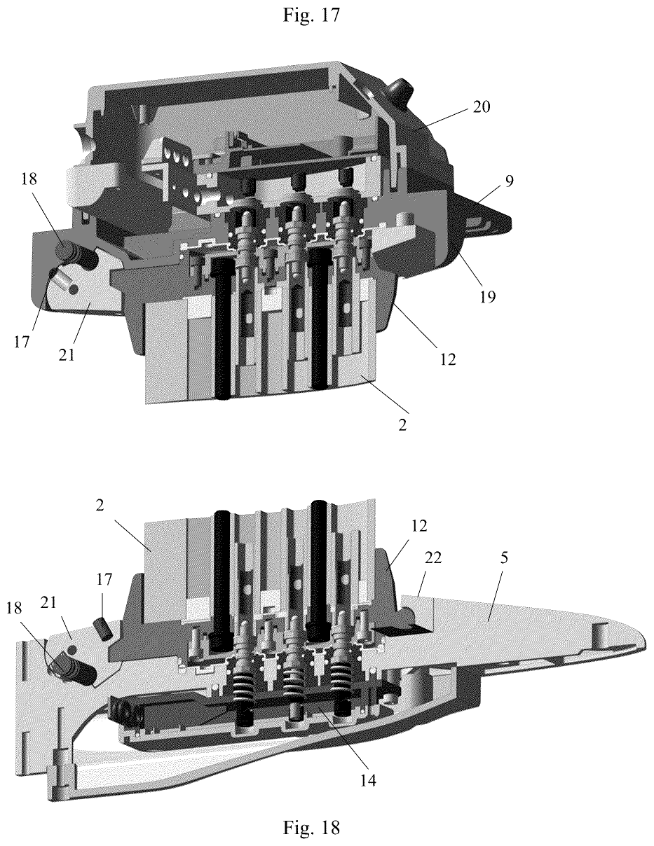

In the case of indirect connection of the mast 2 to the above-water platform 1 (FIG. 17), an airtight box for electronic components 20 installed in a cavity in the board can be used, to which box, on the underside of the board, the attachment module 9 for the mast 2 is detachably or integrally attached, and in which box the contact pins 10 of the cables of the above-water platform 1 are located. Connectors or cables with connectors, which exit the box for electronic components 20, connect to the source of electricity, for example, a battery, which may be mounted both inside and outside the above-water platform 1.

In the case of direct connection of the mast 2 to the above-water platform 1, the attachment module 9, which locks the mast 2 to the above-water platform 1, is mounted directly to the underside of the above-water platform 1 so as to prevent undesired disconnection of the mast 2. In this embodiment of the invention, at the connection point of the mast 2, the attachment module 9 of the above-water platform 1 has contact pins 10 mounted to it, which are connected by cables directly or indirectly by an additional box for electronic components 20 to the battery.

The above-water platform 1, the mast 2 and the fuselage 5 are formed as separate modules, which can be easily and quickly assembled and disassembled using the coupling elements disclosed in the invention.

The attachment module 9 can have a housing, separate or integral with the fuselage housing, for example, on which housing fixing elements such as clamps, arms, elastic rope hooks, spring-loaded pins and their corresponding grooves, braces, screws, or another means known from the state of the art are mounted, by which the necessary fixing of the connection fuselage 5—mast 2—above-water platform 1 can be ensured, by reversibly connecting the attachment module 9 with the coupling element 12 of the mast 2. The waterproofing of the points of connection is ensured by a seal S2 arranged between the mast 2 and the surface to which it is attached, which can be the surface of the fuselage 5, of the above-water platform 1, or of another element mounted to them.

The attachment module 9 can be attached by means of fasteners directly to the above-water platform 1 or the fuselage 5, or it can be an integral part of the fuselage 5 with an attachment socket formed in it, as shown in FIG. 18, or indirectly by another element, for example a box for electronic components 20. Alternatively, the attachment module 9 can have its own housing 19, as shown in FIG. 17, by which it is connected by means of fasteners directly to the above-water platform 1 or the fuselage 5 or to a socket formed in them, or indirectly by another element, for example by a box for electronic components 20. The housing 19 is adapted to ensure the operation of the attachment module 9 depending on its type, for example if the attachment module is a system of two carriers 21, 22, as shown in FIGS. 4, 5, 6, 7, 16 and 17, the housing 19 must provide for the attachment of the carriers to it, as well as their possible movement, if they do so, for example, if there are rotating parts, the housing 19 must have beds in which, by means of a hinged element, to bear the respective rotating parts to ensure the necessary rotation, and a locking means to lock the respective carrier 21, after the assembly is completed, and to unlock it to release the assembly.

A detachable and hermetic electrical connection is provided for the power cables of the underwater propulsion means 6 between the above-water platform 1 and one side of the mast 2 and between the hydrofoil fuselage 5 and the other side of the mast. The electrical connection can be carried out, for example, by touch only or by detachable connection with contact pins, which can be for example male-female connectors, where one connector is inserted into the other connector. In the second case, two connectors on opposite surfaces of the mast 2 and, respectively, on the fuselage 5 or the above-water platform 1, are connected and disconnected from each other by means of a quick connection.

When there is a detachable connection, waterproof and electrically nonconductive seals S2 are arranged between the above-water platform 1 and the mast 2 and between the fuselage 5 and the mast 2, which protect the electrical connection from water penetration and prevent the leakage of electric current. The detachable and hermetic electrical connection between the electrical cables in the mast 2 and, accordingly, the above-water platform 1 and the fuselage 5 of the hydrofoil is carried out by contact pins 10 of the electrical cables provided in the places where the mast 2 is mounted to the above-water platform 1 and the fuselage 5 as well as on both sides of the mast 2. The sides of the contact pins 10 that contact the opposite contact pins 10 can preferably have a one-sided outer coating 13 of a highly conductive material, for example silver or gold plating. This coating 13 provides good contact between the parts through which the necessary high amperage electric current passes.

The contact pins 10 of the above-water platform 1 and the fuselage 5 are in electrical contact with the contact pins 10 of the mast 2 in the assembled state of the watercraft, wherein the contact pins 10 of adjacent cables are electrically isolated from each other.

The hydrofoil electric watercraft has control, regulation and communication electronics, which are mounted in the above-water platform 1 and/or the fuselage 5, and accordingly are not present in the mast 2. According to the invention, the control, regulation and communication electronics of the hydrofoil are a sum of one or more controllers, specifically an electronic speed controller controlling the electric motor, and an electronic module controlling the entire system, called on-board controller or on-board computer. There are cables only in the mast 2, and there are no electronic devices permanently mounted to the coupling elements 12 of the mast 2 that can be removed or disassembled together with the mast 2.

The contact pins 10 can be replaceable and, accordingly, mounted directly or removably and indirectly to the cables of the wire connection between the mast 2, the above-water platform 1 and the fuselage 5. Thus, in case of a defective contact pin, it can easily be replaced without having to replace the entire cables with their respective lugs. Also, in case of oxidized or worn contact pins 10 they can be easily replaced. Direct mounting of the contact pins to the cables can be done, for example, by soldering the cable to the lug. An indirect connection can be provided, for example, by inserting the cables into cable lugs 11, which appear in this version also as cable shoes, in which the cables are fixed, for example, by pressing the cable lug 11 on both sides and deforming it at the end of the cable. In turn, the cable lugs 11 are detachably connected to the contact pins. The cable lugs 11 are made of electrically conductive metal.

All contact pins 10 can be identical for ease of manufacture and serviceability.

In case the contact pins 10 are directly connected to the cables, they can have a cable shoe on one side for connecting the respective cables.

The electrical contact resistance in metal-to-metal contact is determined mainly by the surface structure, mechanical load and electrical conductivity of the material. The rougher is the contact area, the fewer are contact points and contact area, and the lower is the electrical conductivity. The contact surfaces can never be perfectly flat, and there are microscopic roughnesses, which prevent an absolutely tight contact between them. Thus, as shown in FIG. 11, the real contact between two conductors occurs only at bumps (small bumps) on the contact surfaces, resulting in contact resistance. Because of this, the contact between two flat surfaces is worse than the contact between two hemispherical surfaces entering each other due to the larger contact area.

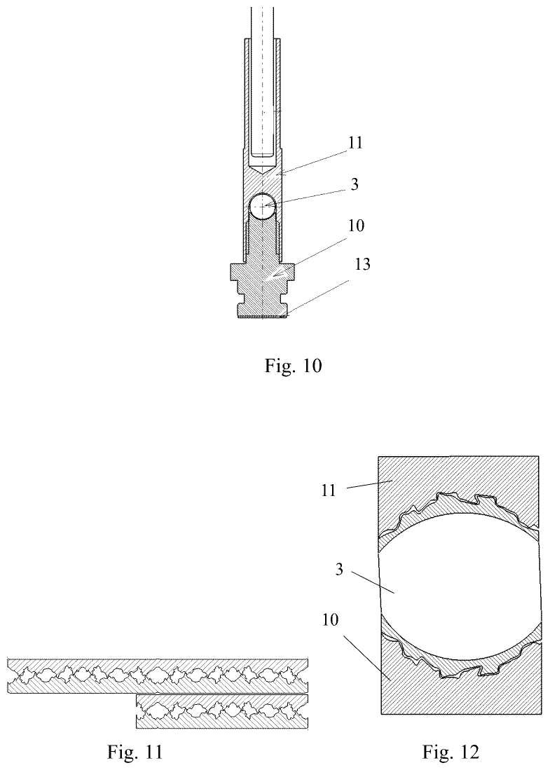

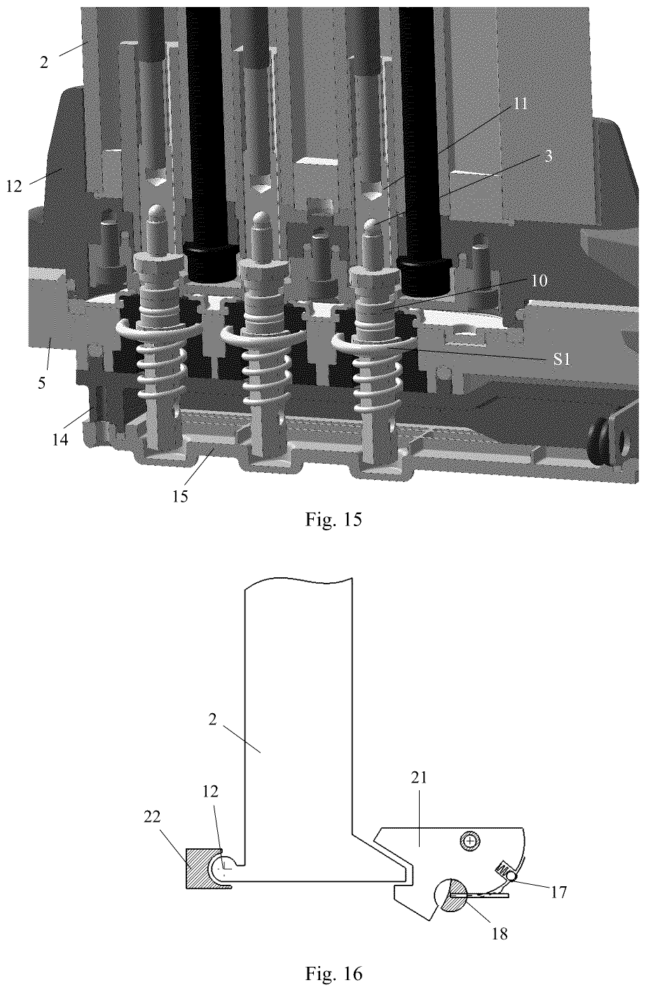

In a preferred embodiment, shown in FIGS. 10 and 15, at least on one side of the connection above-water platform 1—mast 2—fuselage 5, metal cable lugs 11 are mounted on the ends of the cables, which are detachably connected to contact pins 10, and a recess is formed in the shape of a hemisphere at the contact area of each of the contact pins 10 and cable lugs 11, and the two recesses enclose a common spherical cavity, in which a spherical element 3 of electrically highly conductive material with a diameter corresponding to the spherical cavity is located, which spherical element 3 is in electrical contact with both lugs. This connection between two hemispherical elements provides a larger contact area than a contact between two flat elements, and accordingly provides better current transmission and heat transfer (FIG. 11). It is preferable that the spherical element 3 is made of a softer metal than the metal of the contact pins 10 and cable lugs 11, for example, it is made of copper, silver or another suitable metal, in order to increase the contact area between the two lugs when they are connected. When the contact pin 10 is screwed into the cable lug 11 under pressure, the soft material of the spherical element 3 between them is rolled out, after which the surface of the spherical element 3 enters between the roughnesses on the surface of the spherical cavity, as a result of plastic deformation along the tangent, thus increasing the contact area of the contact points of the mounted to each other lugs as shown in FIG. 12.

Preferably, the contact pins 10 are circular in cross-section, but alternatively it is possible to use another cross-sectional shape, depending on the structural necessity.

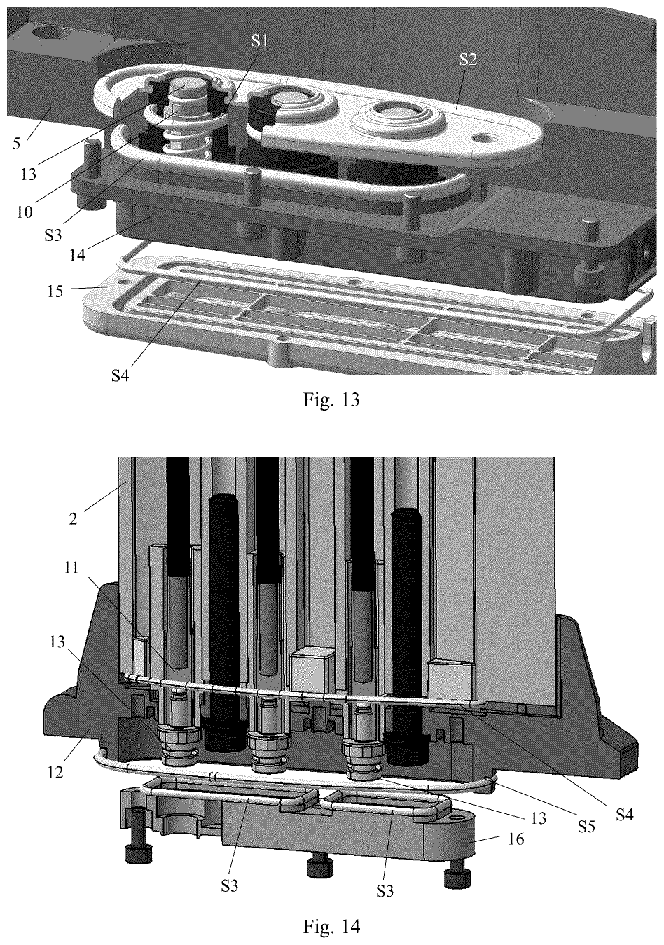

In one embodiment, the contact pins 10 are arranged in contact assemblies 14 located and fixed in the above-water platform 1 and/or the fuselage 5. These contact assemblies 14 have through holes for the passage of the contact pins 10 and provide electrical isolation between them, in the cases, when they are made of electrically insulating material. The contact assemblies 14 can be formed as sealed boxes having openings for the contact pins 10 and for cables and a lid 15, which can have a specially shaped bed to accommodate the end of the contact pins 10 as shown in FIGS. 13 and 15. The connection between the cables and contact pins 10 is carried out in these hermetic contact assemblies 14 in waterproof and electrically isolated environment. In the fuselage 5, the contact assemblies 14 can be fixed to the fuselage's body, on its inner side by means of fixing means and corresponding seals S2, S3, S4, S5, and there can also be an additional lid separating the contact assembly from the rest of the fuselage 5. In the above-water platform 1, for example, the contact assembly 14 can be located and fixed in a special recess on the underside of the above-water platform 1 in the area of mounting of the attachment module 9 to the mast 2. Alternatively, the attachment module 9 can be mounted on the contact assembly 14. In one embodiment (FIG. 17), the contact assembly of the above-water platform is combined with the hermetic box for electronic components 20, so that it is a common hermetic box located and fixed in a known manner in a special recess on the underside of the above-water platform.

Preferably, the contact pins 10 of the mast 2, and/or above-water platform 1 and/or the fuselage 5 are spring-loaded by means of spring elements mounted around the respective contact pins 10. This can be done, for example, as shown in FIG. 15. Electro-contact bushings are arranged on the contact assembly 14, which are mounted to the attachment module 9, which is part of the fuselage's body 5. The bushings have through holes that are coaxial with the through holes for the passage of the contact pins 10 of the corresponding contact assembly 14. Thus, the ends with external coating of highly conductive material of the contact pins 10 protrude through the through holes of the bushings and above them. The through holes of the bushings have an inner ring with a diameter smaller than the diameter of the spring elements, and thus, the spring elements (in this case a cylindrical spring under pressure) abut at their one side the peripheral ring and at their other side they abut the contact assembly 14 without passing through it, and so the spring elements exert the necessary pressure with which springing occurs and they limit their movement along the length of the contact pins 10. In the mounted position on the mast 2 and when the electrical connection is made, spring elements of the spring-loaded contact pins 10 are in a tensioned state so as to provide the necessary pressure between the opposite lugs, thanks to which a better contact between the contact pins 10 and stable passage of the supply current from the battery to the electric motor are ensured. If both contact pins 10 involved in the contact are rigidly mounted, then the place of mounting should be calculated very precisely so that when assembling the mast 2, the lugs should touch without a gap between them or without pressing hard one on another, which would result in damage. Furthermore, when several cables and, accordingly, several pairs of lugs 10 are involved in the electrical connection, the springing facilitates the alignment of adjacent pairs and eliminates the possibility of one of the pairs of contact pins 10 not making contact due to a gap between the lugs 10.

For example, the spring elements of the spring-loaded contact pins 10 on both sides of the mast 2 are in a tensioned state, or alternatively, the spring elements of the spring-loaded contact pins 10 of the above-water platform 1 and the fuselage 5 are in a tensioned state, or alternatively, the spring elements of the spring-loaded contact pins 10 on one side of the mast 2 and of the above-water platform 1 or the fuselage 5 are respectively in a tensioned state.

As shown in FIG. 14, the contact pins 10, which are not spring-loaded, are fixed to a contact pin holder 16 mounted respectively to the mast 2 or to the fuselage's attachment module 5 or to the above-water platform's attachment module 1, by, for example, screws or soldering. A waterproof and electrically nonconductive seal S5 is arranged between this holder 16 and the mast 2. Spacer insulating elements can also be located between the individual contact pins.

Waterproof and electrically nonconductive seals S1, S2, S3, S4, S5 can be made, for example, of silicone or butadiene rubber, or of other suitable material. Seals in the areas of assembly of the mast 2 to the above-water platform 1 or the fuselage 5 can be made of a different shape, for example, sealing two surfaces only on their periphery, or having through holes formed for partial and tight passage of contact pins 10. For example, it is possible, as shown in FIG. 13, that each of the contact pins 10 at one side of the mast-to-platform and mast-to-fuselage connection is located partially and tightly in through holes of a waterproof and electrically nonconductive seal S1, so that the silver-plated outer layer 13 of each of the contact pins protrudes above the plane of the waterproof and electrically nonconductive seal S1. As shown in FIGS. 13, 14 and 15, seals S1, S2, S3, S4, S5 can be placed at any of the following locations: around the contact pins 10, between the mast-platform and mast-fuselage connection areas, between the attachment module and cables passing through it, between individual parts of the attachment module, between the attachment module and the surface of the mast 2/above-water platform 1/fuselage 5 to which it is mounted, between the coupling element 12 and the mast 2, between the coupling element 12 and the holder 16 for contact pins, between the fuselage's body and the contact assembly 14, between the contact assembly 14 and its lid 15; around the entire area of the contact pins 10 inside the attachment module or the coupling element 12 in which they are mounted, or around an electro-contact bushing in which the contact pins 10 are placed.

Preferably, the connection between the above-water platform 1 and the mast 2 and/or between the mast 2 and the fuselage 5 of the hydrofoil is manually detachable without the need of additional tools. Alternatively, it can also be disassembled with the use of tools, for example, screwdrivers, wrenches and others, in which case there are fixing elements such as screws, with which the necessary pressure is applied to the contact system between the fuselage 5 and the mast 2, and between the mast 2 and the above-water platform 1.

As shown in FIGS. 8 and 9, it is preferable that the attachment module 9 of the above-water platform 1 and/or the fuselage 5 has a wedge-shaped socket, tapering in direction of the above-water platform 1 or the fuselage 5, respectively, and the corresponding coupling element 12 of the mast 2, that enters the assembly, to have a wedge-shaped end, tapering in direction of the wedge-shaped socket to which it is mounted. Preferably, the angle of the wedge is 8° (FIG. 7), but it is also possible for the angle of the wedge to be 6°, 7°, 9°, 10° or any other suitable angle. In this way, a geometric assembly of the two wedge-shaped parts is obtained, which limits the lateral swaying of the mast 2 with respect to the fuselage 5 or the above-water platform 1, due to the constant tendency to turn to the side of the large front wing 7 of the hydrofoil. Possible wedge-shaped variants of the attachment module 9 of the above-water platform 1 and/or the attachment module 9 of the fuselage 5 and their corresponding coupling element 12 of the mast 2 are, for example, conical, cylindrical, truncated pyramidal, cuboidal, or other suitable shape, as long as it is suitable to carry out an assembly.

The coupling element 12 of the mast 2 can have shaped grooves or protruding ribs or other holding elements by which it engages and fixes to the elements of the attachment module 9.

It is possible that the mast 2 is detachably connected to one or both of its coupling elements 12, and a waterproof and electrically nonconductive seal S4 is arranged between the mast 2 and its corresponding coupling element 12. Alternatively, it is possible that the mast 2 is integrally connected to one or both of the coupling elements 12.

Preferably, the mast 2 is symmetrical on both sides with identical coupling elements 12, so that it does not matter which side will be mounted to the above-water platform 1 and which to the fuselage 5, which is a convenience for users.

The connection between the above-water platform 1 and the mast 2 and between the mast 2 and the fuselage 5 of the hydrofoil can be provided in several ways:

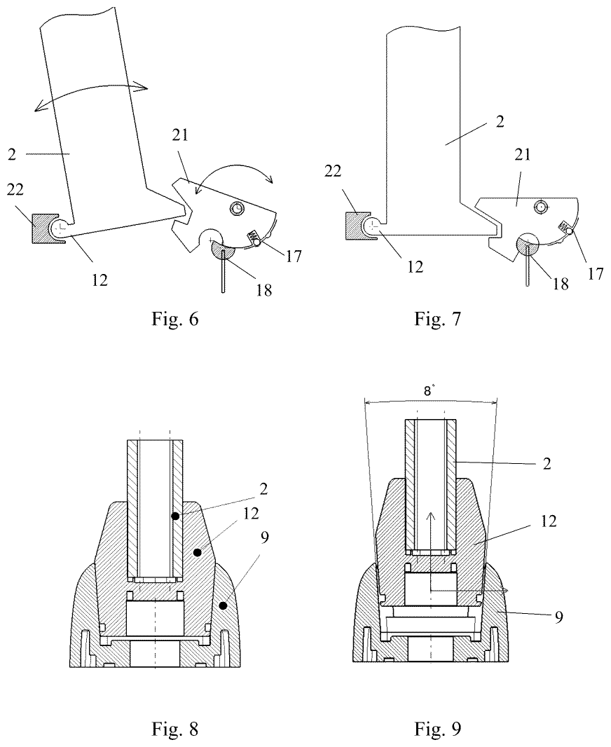

As shown in FIGS. 1, 4, 5, 6, 7, 16, 17 and 18, an attachment module 9 with a housing 19 can be provided, mounted, respectively, to the above-water platform 1 and/or to the fuselage 5, being a system of two carriers 21, 22, respectively, a first carrier 22 and a second carrier 21, one of which is stationary and the other is movable, which are arranged at a distance from each other less than the length of the coupling element 12 of the mast 2, wherein the attachment module 9 has unlocked and locked position. The first carrier 22 (the stationary) has, on the opposite to the second carrier 21 side, an engaging element for a corresponding first engaging element of the coupling element 12 of the mast 2, so that the two engaging elements form a hinge connection. The coupling element 12 of the mast 2 together with the entire mast 2 is placed at an angle relative to the above-water platform or, respectively, the fuselage 5, after which it performs a rotational movement around the axis of the hinge connection between the engaging element of the first carrier 22 and the first engaging element of the mast 2 between unlocked and locked position, the rotational movement ending when the contact side of the coupling element 12 of the mast 2 abuts against the surface to which it is attached. The movement can be both in direction from the nose of the above-water platform 1 to its rear, and vice versa—from its rear to the nose. In the locked position of the attachment module 9, an engaging element of the second carrier 21 (movable) forms a releasable connection with second engaging element of the coupling element 12 of the mast 2, arranged on the opposite to the first engaging element of the coupling element 12 side. The engaging element of the first carrier 22 is a groove, and the engaging elements of the coupling element 12 of the mast 2 are ribs, and the second carrier 21 is, preferably, a rotating body having an engaging element which is a groove, and wherein the grooves of the two carriers 21, 22 are opposite to each other in the locked position of the attachment module 9. Alternatively, it is possible to have a fixed second carrier to which the second end of the coupling element 12 of the mast 2 is mounted by means of tools or by other known means. In the variant with rotating carrier 21, the rotating body performs a reciprocating-rotary movement around an axis parallel to the axis of the hinge connection between the engaging elements synchronously with the rotational movement of the coupling element 12 of the mast 2. The rotating body has a locking means 18 for holding the mast 2 in assembled state. The locking means 18 can be, for example, a semi-cylindrical element with a lever projecting perpendicularly to the extension of the semi-cylindrical element, by means of which the semi-cylindrical element can be rotated by a user in semi-cylindrical cavity formed in the rotating body with an outer and an inner edge relative to the point of attachment of the mast 2. In unlocked position of the rotating body and before the mast 2 takes its final position for assembly, the semi-cylindrical element of the locking means 18 is located outside the semi-cylindrical cavity of the rotating body. By rotating the mast 2 around the axis towards the stationary carrier 22, and after the mast 2 reaches its final position for assembly, the semi-cylindrical element of the locking means 18 gradually fits into the semi-cylindrical cavity of the rotating body. In the usual case, the mast 2 is perpendicular to an imaginary plane of the extension from the front to the rear end of the above-water platform 1 or the fuselage 5. The semi-cylindrical cavity has an opening from which the lever of the locking means 18 protrudes after the semi-cylindrical element is located in it. The size of the opening is large enough so that when the lever is at one end of the opening or in an intermediate position between the two ends of the opening, in which the semi-cylindrical element does not abut the outer edge of the semi-cylindrical cavity, the locking means 18 is in unlocked position, and when the lever is at the opposite end of the opening and the semi-cylindrical element abuts the outer edge of the semi-cylindrical cavity, the locking means 18 is in locked position and cannot be rotated because the semi-cylindrical element holds the rotating body, and the lever cannot be rotated back into unlocked position without user pressure applied to it. The locking means 18 is fixed to the housing 19 of the attachment module, in a suitable place, so as to provide the necessary connection with the rotating body. When the assembly is locked, the contact points are connected, which creates the necessary connection between the electrically conductive parts from the electric motor to the above-water control system. The rotating body can also have a spring-ball element 17 to ensure locking of the rotating body in the final open position, as shown in FIGS. 6 and 7. This spring-ball element 17 is a spring with a ball at one end, arranged in separate opening of the rotating body. Between the opening for the spring and the ball of the rotating body, and the surface to which they contact a curved plate is located, which has a shape corresponding to the profile of the rotating body, which plate is fixed to the housing 19 of the attachment module 9 so as to be in contact with the ball. The plate has two hemispherical grooves located in one plane with the ball, and when the rotating body rotates, the ball enters into one of the two grooves, from where it cannot come out without applying additional pressure. Accordingly, when the ball enters one groove, the rotating body is in its final open position, in which the mast 2 can be placed, and when the ball enters the other groove, the rotating body is in its final closed position, in which it can be locked. It is possible that both the first carrier 22 and the second carrier 21 are located at the nose of the above-water platform 1. Likewise, after assembly with the fuselage 5, it is possible that both the first carrier 22 and the second carrier 21 are located at its front part;

As shown in FIG. 2, it is possible that the connection between the above-water platform 1 and the mast 2 and/or between the mast 2 and the fuselage 5 of the hydrofoil is a rail connection, wherein the assembly with the mast 2 is provided by fixing a detachable attachment module 9, respectively, to the above-water platform 1 and/or to the fuselage 5. The coupling element 12 of the mast 2 has rails, which sliding into corresponding rails mounted on the attachment module 9 of the above-water platform 1 and/or the fuselage 5, adjusts the contact points and the necessary connection of the contact points of the conductive parts from the electric motor to the control system of the above-water part is created. There can be two rails of the attachment module 9, between which the rails of the coupling element 12 of the mast 2 are slid. Alternatively, each of the attachment modules 9 or the coupling elements 12 can have more rails, as long as their number corresponds to each other so that they can engage;

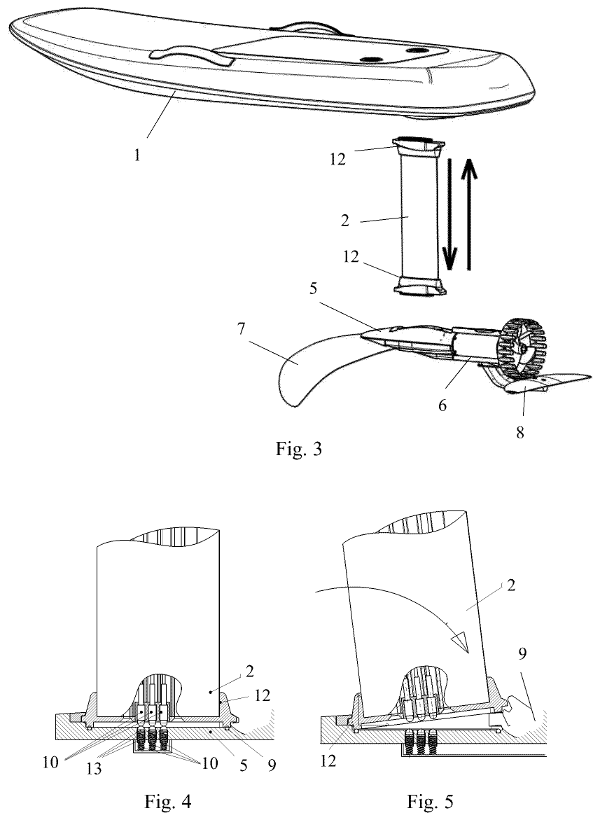

as shown in FIG. 3, it is possible for the attachment module 9 of the above-water platform 1 and/or the fuselage 5 of the hydrofoil to have a connection socket for the mast 2, designed so that the coupling element 12 of the mast 2 can be assembled and disassembled with reciprocating movement, wherein it is inserted into or removed from the socket in a direction parallel to the extension of the mast 2. Thus, when connecting the mast 2, the necessary pressure is created on the contact points of the conductive parts from the electric motor to the control system of the above-water part. Once assembled, the mast 2 is fixed by fixing means to the attachment module 9 of the above-water platform 1 and/or the fuselage 5.

Preferably, the coupling elements 12 on both sides of the mast 2 are identical, and the attachment modules, respectively, of the above-water platform 1 and the fuselage 5 are also identical. This facilitates production and operation of the hydrofoil. Alternative variants with different shapes and sizes of coupling elements 12 are also possible.

It is also possible to use additional pieces that constructively support the attachment of the mast 2 to the above-water platform 1, and accordingly the place of attachment of the mast 2 to the above-water platform 1 can coincide with these pieces. Such pieces are, for example, mounting plates or pieces that modify the profile of the mast 2 at the end, which is mounted to the above-water platform 1. It is also possible to use such additional pieces as, for example, pads that allow changing the mounting angle of the front wing or the rear main stabilizer.

The hydrofoil elements are made of the usual suitable materials known in the state of the art. The stabilizer 8, the front wing 7 and if there is an additional stabilizer 4, for example, can be made of composite materials such as fiberglass and carbon, plastic or aluminum. The above-water platform 1 can be made of expanded polystyrene (EPS), expanded polypropylene (EPP), impregnated plywood, etc. Also, the listed materials can be in combination with carbon coating applied by a suitable known method.

The reference numbers of the technical features are included in the claims solely for the purpose of increasing the comprehensibility of the claims and, therefore, these reference numbers do not have any limiting effect on the interpretation of the elements indicated by these reference numbers.

What is claimed is:

1. A modular electric hydrofoil watercraft comprising:
above-water platform,
hydrofoil comprising a fuselage with a front wing and at least one stabilizer,
mast connecting directly or indirectly the above-water platform to the fuselage of the hydrofoil, wherein there is one coupling element at each end of the mast for mechanical fastening, respectively, to the above-water platform and to the fuselage of the hydrofoil, and
underwater propulsion means mounted to the fuselage, said underwater propulsion means is for creating horizontal thrust and has at least one electric motor connected by wire via electric cables located inside the mast to a source of electricity located in or on the above-water platform,
wherein the mast is detachably connected to the above-water platform and to the fuselage of the hydrofoil, wherein the mast is adapted to be quickly and easily disassembled from and assembled to the above-water platform and the fuselage, wherein at least one attachment module is provided for detachable mechanical attachment of a corresponding coupling element of the mast in the location where the mast is mounted to the above-water platform and the fuselage, wherein a detachable and hermetic electrical connection is provided for cables providing power and/or communication to the underwater propulsion means between the above-water platform and one side of the mast and between the fuselage of the hydrofoil and the other side of the mast, wherein waterproof and electrical nonconductive seals are placed between the above-water platform and the mast and between the fuselage and the mast when the detachable connection is built, wherein the detachable and hermetic electrical connection between the electrical cables in the mast and, accordingly, in the above-water platform and the fuselage of the hydrofoil is contact pins of the electrical cables provided at the places where the mast (2) is mounted to the above-water platform and the fuselage and on both sides of the mast, wherein the contact pins of the above-water platform and the fuselage are in electrical contact with the contact pins of the mast in the assembled state of the watercraft, and wherein the contact pins of adjacent cables are electrically isolated from each other, wherein a control, regulation and communication electronics of the hydrofoil is mounted in the above-water platform and/or the fuselage.

2. The modular electric hydrofoil watercraft according to claim 1, wherein the contact pins are replaceable and the cables of the wire connection between the mast, the above-water platform and/or the fuselage are directly or indirectly mounted to them.

3. The modular electric hydrofoil watercraft according to claim 2, wherein metal cable lugs are mounted on the ends of the cables at least on one side of the connection mast-above-water platform and/or of the connection mast-fuselage, which metal cable lugs are detachably connected to the contact pins, each of the contact pins and cable lugs has a hemispherical recess in the contact area between the contact pins and the cable lugs, the two recesses enclose a common spherical cavity in which a spherical element of electrically highly conductive material with a diameter corresponding to the spherical cavity is arranged, which spherical element is in electrical contact with both lugs.

4. The modular electric hydrofoil watercraft according to claim 3, wherein the spherical element is made of a softer metal than the metal of which the contact pins and cable lugs are made.

5. The modular electric hydrofoil watercraft according to claim 1, wherein the contact pins of the mast, and/or the above-water platform and/or the fuselage are spring-loaded by spring elements for contact pins mounted around the corresponding contact pins, wherein in the mounted position on the mast and when the electrical connection is established, spring elements for contact pins of the spring-loaded contact pins of at least one of the parts of the watercraft are tensioned.

6. The modular electric hydrofoil watercraft according to claim 1, wherein the connection between the above-water platform and the mast and/or between the mast and the fuselage of the hydrofoil is manually detachable.

7. The modular electric hydrofoil watercraft according to claim 1, wherein the attachment module of the above-water platform and/or attachment module of the fuselage is made with a wedge-shaped socket, tapering in direction, respectively, of the above-water platform or the fuselage, and the corresponding coupling element of the mast, providing an assembly, respectively, with the above-water platform or with the fuselage has a wedge-shaped end, tapering in direction of the wedge-shaped socket to which it is mounted.

8. The modular electric hydrofoil watercraft according to claim 1, wherein the mast and at least one of its coupling elements are detachably connected to each other, and a waterproof and electrically nonconductive seal (S4) is arranged between them.

9. The modular electric hydrofoil watercraft according to claim 1, wherein the connection between the above-water platform and the mast and/or between the mast and the fuselage of the hydrofoil is provided by an attachment module which is mounted, respectively, to the above-water platform and/or the fuselage, which attachment module is a system of two carriers, respectively first carrier and second carrier, which are arranged at a distance from each other less than the length of the coupling element of the mast, wherein the attachment module has unlocked and locked position, wherein the first carrier has, on the opposite to the second carrier side, engaging element for a corresponding first engaging element of the coupling element of the mast, wherein the coupling element of the mast is configured for a rotational movement centered on the first engaging element of the first carrier between unlocked and locked positions, and in the locked position of the attachment module (9), an engaging element of the second carrier forms a releasable assembly with a second engaging element of the coupling element of the mast, arranged on the opposite to the first engaging element side of the coupling element.

10. The modular electric hydrofoil watercraft according to claim 9, wherein the engaging element of the first carrier is a groove and the engaging elements of the coupling element of the mast are ribs, the second carrier is a rotating body having an engaging element in the form of a groove, and wherein the grooves of the two carriers are opposite to each other in locked position of the attachment module, wherein the rotating body is configured with the ability to perform synchronous to the rotational movement of the coupling element of the mast reciprocating-rotating movement around an axis that is transverse to the extension of the above-water platform and/or the fuselage, when engaging with the coupling element of the mast, wherein the rotating body has a locking means to hold the mast in the assembled state.

11. The modular electric hydrofoil watercraft according to claim 1, wherein the connection between the above-water platform and the mast and/or between the mast and the fuselage of the hydrofoil is a rail connection, wherein in the assembled state, the mast is fixed by a detachable attachment module, respectively, to the above-water platform and/or to the fuselage.

12. The modular electric hydrofoil watercraft according to claim 1, wherein the above-water platform and/or the fuselage of the hydrofoil have a connection socket for the mast configured so that the coupling element of the mast, in the assembled state, is inserted into the socket in direction parallel to the extension of the mast, wherein in the assembled state the mast is fixed by means of an attachment module to the above-water platform and/or to the fuselage.

13. The modular electric hydrofoil watercraft according to claim 1, wherein the above-water platform has a box for electronic components located in a cavity in the board, to which box the attachment module for the mast is attached detachably or integrally and in which box the contact pins of the cables of the above-water platform are located.

14. The modular electric hydrofoil watercraft according to claim 1, wherein the coupling elements on both sides of the mast are identical, and the attachment modules, respectively, of the above-water platform and the fuselage are identical also.
